(19) United States
(12) Patent Application Publication
(10) Pub. No.: US 2015/0064395 A1
(43) Pub. Date: Mar. 5, 2015

(54) Formed Articles Comprising Carbon And Natural Fibers, Methods Of Manufacture And Use Thereof

(71) Applicant: International Automotive Components Group North America, Inc., Southfield, MI (US)

(72) Inventor: Marc A. HAYES, Plymouth, MI (US)

(21) Appl. No.: 14/461,107

(22) Filed: Aug. 15, 2014

Related U.S. Application Data
(60) Provisional application No. 61/871,825, filed on Aug. 29, 2013.

(51) Int. Cl. B32B 5/24; D04H 13/00; B32B 5/26

(52) U.S. Cl. CPC B32B 5/24; B32B 5/245; B32B 5/26; D04H 13/001
USPC 428/116; 428/219; 428/212; 442/416; 442/334; 442/391; 442/373; 442/1; 442/394

(57) ABSTRACT

A fiber mat comprising a first fiber layer, the first fiber layer formed by combining 45-55% by weight of synthetic polymer fibers; 35-45% by weight of natural fibers; and 5-15% by weight of carbon fibers, as well as a formed article comprising a molded substrate formed from a fiber mat, the fiber mat comprising a first fiber layer formed by combining 45-55% by weight of synthetic polymer fibers; 35-45% by weight of natural fibers; and 5-15% by weight of carbon fibers.

### CROSS REFERENCE TO RELATED APPLICATIONS

The present application claims the benefit of the filing date of U.S. Provisional Application Ser. No. 61/871,825, filed Aug. 29, 2013, the teachings of which are incorporated herein by reference.

### FIELD

The present disclosure relates to the manufacture of light weight formed articles comprising carbon and natural fibers, and associated method of processing and manufacturing.

### BACKGROUND

Environmentally conscious manufactures may seek to reduce the carbon footprint of their products by use of recycled/reclaimed materials, as well as materials from renewable resources.

In the transportation industry, many articles are formed of fiber reinforced composites, in which fibers are generally embedded in a cured resin. In particular, the airline industry makes use of carbon fiber reinforced composite articles for many structural components due to the high strength-to-weight ratio of such materials.

The processes of manufacturing carbon fiber reinforced composite articles necessarily creates process scrap. Manufacturing process scrap from the manufacture of carbon fiber reinforced composite articles may include unused (virgin) carbon fiber, as well as carbon fiber with various surface treatments (e.g. bonding agents) and resin impregnation. Such scrap may generally be in the form of trim waste or rejected (defective) formed articles.

Furthermore, the carbon fiber reinforced composite article itself similarly becomes scrap at the end of its useful life. End-of-life (EOL) scrap, as opposed to manufacturing scrap, may include carbon fiber embedded in a cured resin which has been subjected to environmental exposure. EOL scrap may include additional components added to the carbon fiber reinforced composite article after manufacture (e.g. coatings, fasteners), as well as contaminants.

Processes have been developed to reclaim carbon fiber from fiber reinforced composite articles at the various stages of manufacture, as well as at the end of the article's useful life. However, given the properties of reclaimed carbon fiber may be considered inferior to virgin carbon fiber, there has been resistance in the airline industry to incorporating such reclaimed carbon fiber back into aircraft components.

In the automotive industry, on the other hand, automotive manufactures do not widely utilize virgin carbon fiber. Virgin carbon fiber is generally considered too expensive for economical use, except in limited applications demanding the strength-to-weight ratio of carbon fiber reinforced composite articles. Rather, automotive manufactures have utilized glass fibers for many years, and have more recently made greater use of certain natural fibers, particularly for weight reduction. However, natural fibers often do not offer the physical properties or dimensional stability of glass fibers.

What is needed for certain automotive applications is an improved fiber reinforcement which will further reduce weight, as well as provide an increase in physical properties and dimensional stability, without a significant negative cost impact.

### SUMMARY

In one embodiment of the present disclosure, the disclosure provides a fiber mat comprising a first fiber layer, the first fiber layer formed by combining 45-55% by weight of synthetic polymer fibers; 35-45% by weight of natural fibers; and 5-15% by weight of carbon fibers.

In another embodiment of the present disclosure, the disclosure provides a fiber mat comprising a core layer sandwiched between first fiber layer and the second fiber layer; the first fiber layer formed by combining 45-55% by weight of synthetic polymer fibers; 35-45% by weight of natural fibers; and 5-15% by weight of carbon fibers; and the second fiber layer formed by combining 45-55% by weight of synthetic polymer fibers; 35-45% by weight of natural fibers; and 5-15% by weight of carbon fibers.

In another embodiment of the present disclosure, the disclosure provides a formed article comprising a molded substrate formed from a fiber mat, the fiber mat comprising a first fiber layer formed by combining 45-55% by weight of synthetic polymer fibers; 35-45% by weight of natural fibers; and 5-15% by weight of carbon fibers.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a cross-sectional view of a first fiber mat according to the present disclosure;

FIG. 2 is a cross-sectional view of a second fiber mat according to the present disclosure;

FIG. 3 is a flow diagram of a manufacturing process to make a formed article from the fiber mat of FIG. 1 or 2; and

FIG. 4 is a flow diagram of an alternative manufacturing process to make a formed article from the fiber mat of FIG. 1 or 2.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

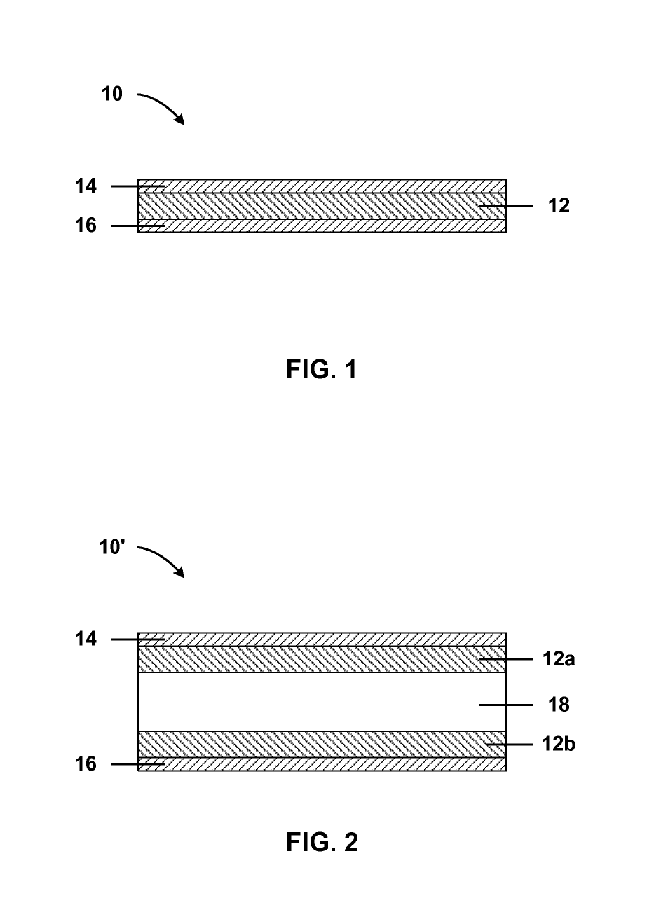

Referring now to the figures, FIG. 1 shows a first exemplary embodiment of a planar fiber mat 10 according to the present disclosure. As shown fiber mat 10 comprises a first fiber layer 12. Fiber layer 12 may particularly comprise fibers of different material compositions as follows:
45-55% by weight of fiber layer 12 may be formed from polymer fibers, and more particularly, synthetic polymer fibers. Exemplary synthetic polymer fibers may include polypropylene fibers, which may further include fibers of polypropylene homopolymer(s) and/or polypropylene copolymer(s) (e.g. polypropylene-maleic anhydride copolymer). The polymer fibers may have a length of 8 mm to 40 mm, and more particularly 12 mm to 25 mm. The polymer fibers may particularly have a melt flow index of 0.1-10 g/10 min. determined according to ASTM D 1238-13 at 230° C. under a load of 2.16 kg, and more particularly 0.6-6 g/10 min. determined according to ASTM D 1238-13 at 230° C. under a load of 2.16 kg.
35-45% by weight of the fiber layer 12 may be formed from natural fibers. Exemplary natural fibers may include one or more of kenaf, flax, jute hemp, sisal and cellulose. The natural fibers may have a length of 8 mm to 40 mm, and more particularly 12 mm to 25 mm; and
5-15% by weight of the fiber layer 12 may be formed from carbon fibers. The carbon fibers may further include virgin and/or reclaimed carbon fibers. The carbon fibers may have a length of 8 mm to 40 mm, and more particularly 12 mm to 25 mm.

Fiber layer 12 may be particularly formed as a planar sheet via the process disclosed in U.S. Patent Application Publication No. 2010/0261014, entitled Utilization of Recycled Carbon Fiber, the teachings of which are hereby incorporated by reference in its entirety. Fiber layer 12 may also be particularly formed as a planar sheet via a dry-laid non-woven fabric manufacturing process, such as an airlay process. Fiber layer 12 may particularly have an area weight of 500-1,000 grams/square meter (gsm).

In one exemplary embodiment, made using the process disclosed in U.S. Patent Application Publication No. 2010/0261014, a fiber layer 12 having a 840 gsm weight may be formed from the following:
50% polypropylene-maleic anhydride copolymer fiber comprising 95-99% by weight polypropylene and 1-5% by weight maleic anhydride as a comonomer to the polypropylene;
40% natural fiber of which 38% is a combination of kenaf, jute and flax, and 2% are cellulose fibers; and
10% reclaimed carbon fiber.

In addition to fiber layer 12, fiber mat 10 may further comprise second and third fiber layers 14, 16, particularly of nonwoven scrim having an area weight of 30-100 gsm, and more particularly having an area weigh of 50-75 gsm, which are positioned on opposing front and rear sides of the first fiber layer 12, respectively. The nonwoven scrim may be particularly formed of polyethylene terephthalate, which may be used to promote bonding to the fiber mat 10 to a decorative cover, as well as promote bonding to subsequently formed ribs and fastening locations, as explained in greater detail below.

As compared to a fiber mat which does not make use of a fiber layer 12 containing carbon fiber, fiber mat 10 according to the present disclosure may exhibit the following increases in tensile strength and heat distortion temperature physical properties.

| | Area | Tensile | Heat |
|---|---|---|---|
| | Weight | Strength¹ | Distortion |
| Composition | (gsm) | (MPa) | Temp² (° C.) |
| 50% PP (w/ma); 50% natural | 1,200 | 16.0 | 123.1 |
| fiber.³ (Baseline) | | | |
| 50% PP (w/ma), 8% carbon | 700 | 17.5 | 123.2 |
| fiber, 42% natural fiber | | | |
| 50% PP (w/ma), 8% carbon | 1060 | 19.0 | 154.3 |
| fiber, 42% natural fiber | | | |
| 50% PP (w/ma), 15% carbon | 600 | 22.0 | 145.2 |
| fiber, 35% natural fiber | | | |
| 50% PP (w/ma), 15% carbon | 900 | 29.0 | 153.1 |
| fiber, 35% natural fiber | | | |

Footnotes:
¹ASTM D638-10, 50 mm/min.
²ASTM D648-07.
³50% polypropylene-maleic anhydride copolymer fiber comprising 95-99% by weight polypropylene and 1-5% by weight maleic anhydride as a comonomer to the polypropylene.

In a second embodiment of fiber mat 10 as shown in FIG. 2, fiber mat 10′ may comprise a core 18 sandwiched between two opposing fiber layers 12a, 12b. Core 18 may have an area weight of 300-1,000 gsm and a thickness of 0.5 to 1.5 mm. The core 18 may be formed of shoddy, cardboard, honeycomb and polyurethane foam. As compared with the first embodiment, fiber layers 12a, 12b may each have an area weight of 100-600 gsm.

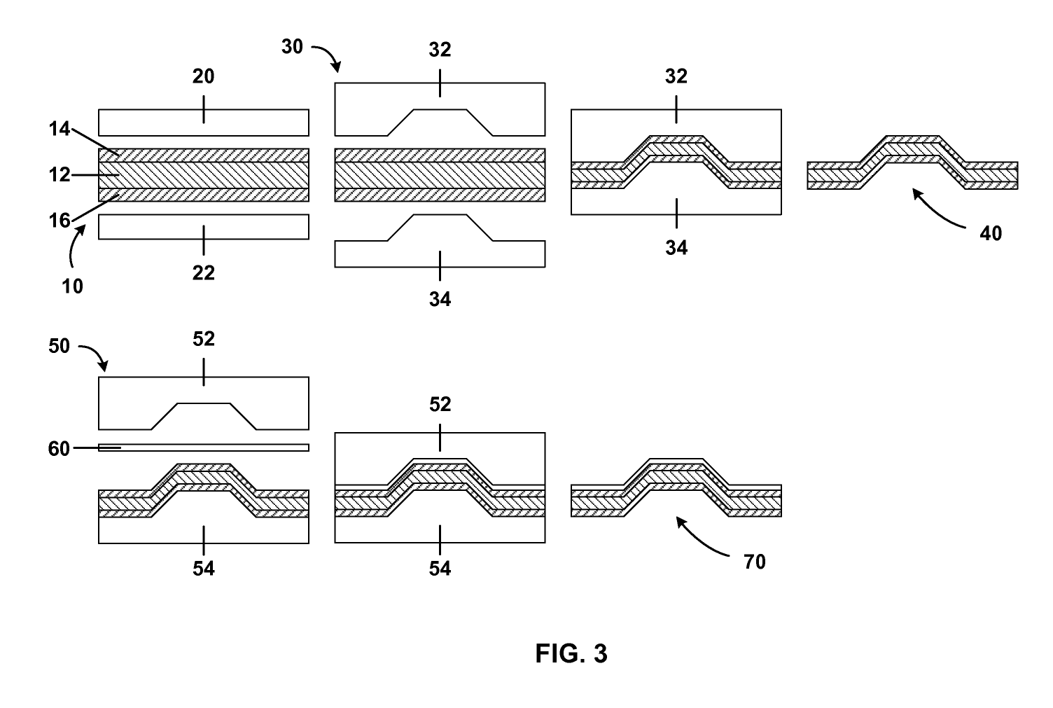

As shown in FIG. 3, fiber mat 10 may be used to manufacture a formed article 70. Article 70 may be formed by first heating the fiber mat 10 between two opposing heated platens 20, 22 to a temperature of 375-425° C. for a period of 45-60 seconds, or otherwise until the fiber mat 10 reaches a temperature of 400° C. Once the fiber mat 10 is sufficiently heated, the fiber mat 10 may be placed between two opposing halves 32, 34 of a first heated compression mold 30. Compression mold may be heated to a temperature of 60-120° C. The mold 30 may be closed and the fiber mat 10 formed into a substrate 40, during which time the synthetic polymer fibers may flow under compression to form substrate 40. The substrate 40 may then cool and be removed from compression mold 30. Substrate 40 may have a thickness 0.5-2 mm, and more particularly have a thickness of 1-1.5 mm.

Thereafter, the substrate 40 may placed between two opposing halves 52, 54 of second compression mold 50, along with decorative cover layer 60, which may be in the form of a sheet. Thereafter, the second compression mold 50 may be closed to compression mold and laminate the decorative cover layer 60 to the substrate 40 to form formed article 70, with the adhesive layer of the decorative cover layer 60 bonding to outer scrim layer 14 of the substrate 40.

Decorative cover layer 60 may formed of polyvinyl chloride (PVC), thermoplastic urethane (TPU), and thermoplastic olefin (TPO). Decorative cover layer may have a thickness in a range of 0.5-2.5 mm, and may be more particularly formed of a polyvinyl chloride (PVC), thermoplastic urethane (TPU), and thermoplastic olefin (TPO) outer skin overlying a cushion layer of polyvinyl chloride (PVC) or polyolefin foam. Decorative cover layer may include a grained outer surface and an adhesive coated inner surface to bond to the substrate 40.

In alternative embodiments, decorative cover layer 60 may be introduced to first compression mold 30 along with fiber mat 10 to form article 70 in one step, here with a single mold 30.

Also in alternative embodiments, it should be understood that decorative layer 60 is not necessarily required, and the formed article 70 may merely comprise substrate 40. It should also be understood that fiber mat 10′ may be substituted for fiber mat 10′ shown in the process of FIG. 3.

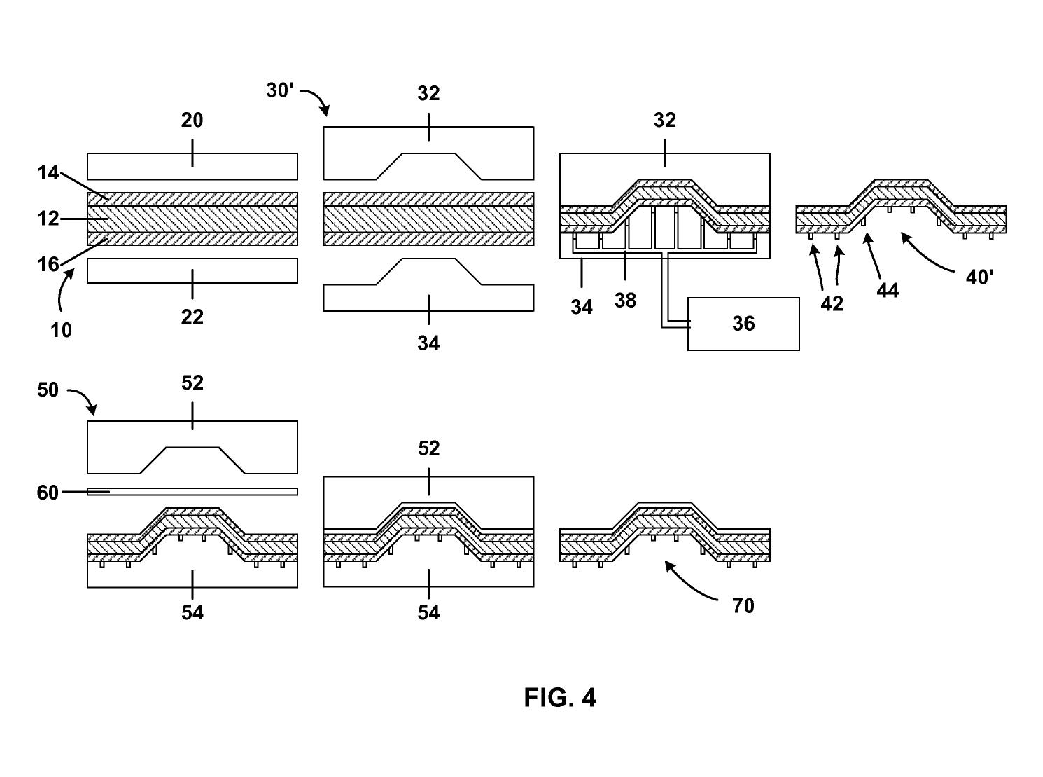

In another alternative embodiment of the process of FIG. 3, as shown in FIG. 4, the compression mold 30 may be configured as an injection-compression mold 30′, which is configured to receive resin from a polymer delivery unit 36, such as a screw plastication unit of an injection molding machine used for injection-compression molding. Here, after compression molding of the fiber mat 10, polymer delivery unit 38, in conjunction with a suitable runner 38 in mold half 34, may deliver polymer material to the backside of the compression molded substrate to mold a plurality of elongated reinforcement (stiffening) ribs 42 which extend along a length of the substrate 40′, as well as fastening locations (e.g. screw bosses, dog houses), to the backside of the substrate 40′.

Formed article 70 may particularly be a trim member for a motor vehicle such as an interior or exterior trim panel such as a side trim panel (e.g. door trim panel); a package tray, a headliner, an instrument panel, an upper or lower instrument panel close-out panel, a console, a trunk liner, a door bolster, a knee bolster and a seat back,

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

1. A fiber mat comprising:
a first fiber layer, the first fiber layer formed by combining 45-55% by weight of synthetic polymer fibers; 35-45% by weight of natural fibers; and 5-15% by weight of carbon fibers.

2. The fiber mat of claim 1 wherein:
the fiber layer has an area weight in a range of 500-1,000 grams/square meter.

3. The fiber mat of claim 1 wherein:
the carbon fibers comprise at least one of virgin carbon fibers and reclaimed carbon fibers.

4. The fiber mat of claim 1 wherein:
the carbon fibers have a length in a range of 8-40 millimeters.

5. The fiber mat of claim 1 wherein:
the natural fibers comprise at least one of kenaf, jute, flax and cellulose fibers.

6. The fiber mat of claim 1 wherein:
the natural fibers have a length in a range of 8-40 millimeters.

7. The fiber mat of claim 1 wherein:
the synthetic polymer fibers comprise thermoplastic fibers.

8. The fiber mat of claim 1 wherein:
the synthetic polymer fibers comprise polypropylene fibers.

9. The fiber mat of claim 8 wherein:
the polypropylene fibers comprise polypropylene-maleic anhydride copolymer.

10. The fiber mat of claim 1 wherein:
the synthetic polymer fibers have a length in a range of 8-40 millimeters.

11. The fiber mat of claim 1 further comprising:
a second fiber layer on a front side of the first fiber layer, the second fiber layer comprising a scrim layer having an area weight in a range of 30-100 grams/square meter.

12. The fiber mat of claim 11 wherein:
the fibers of the second fiber layer comprise polyethylene terephthalate fibers.

13. The fiber mat of claim 11 further comprising:
a third fiber layer on a rear side of the first fiber layer, the third fiber layer comprising a scrim layer having an area weight in a range of 30-100 grams/square meter.

14. A fiber mat of claim 13 comprising:
the fibers of the third fiber layer comprise polyethylene terephthalate fibers.

15. A fiber mat comprising:
a core layer sandwiched between first fiber layer and the second fiber layer;
the first fiber layer formed by combining 45-55% by weight of synthetic polymer fibers; 35-45% by weight of natural fibers; and 5-15% by weight of carbon fibers; and
the second fiber layer formed by combining 45-55% by weight of synthetic polymer fibers; 35-45% by weight of natural fibers; and 5-15% by weight of carbon fibers.

16. The fiber mat of claim 15 wherein:
the first fiber layer has an area weight in a range of 100-600 grams/square meter; and
the second fiber layer has an area weight in a range of 100-600 grams/square meter.

17. The fiber mat of claim 15 wherein:
the core has an area weight in a range of 300-1,000 grams/square meter.

18. The fiber mat of claim 15 wherein:
the core layer is formed of at least one of polymer foam, honeycomb, cardboard, and metal mesh.

19. A formed article comprising:
a molded substrate formed from a fiber mat, the fiber mat comprising a first fiber layer formed by combining 45-55% by weight of synthetic polymer fibers; 35-45% by weight of natural fibers; and 5-15% by weight of carbon fibers.

20. The formed article of claim 19 wherein:
the first fiber layer has an area weight in a range of 500-1,000 grams/square meter.

21. The formed article of claim 19 wherein:
the fiber mat comprises a second fiber layer formed by combining 45-55% by weight of synthetic polymer fibers; 35-45% by weight of natural fibers; and 5-15% by weight of carbon fibers.

22. The formed article of claim 21 wherein:
the first fiber layer has an area weight in a range of 100-600 grams/square meter; and
the second fiber layer has an area weight in a range of 100-600 grams/square meter.

23. The formed article of claim 21 further comprising:
a core layer sandwiched between first fiber layer and the second fiber layer.

24. The formed article of claim 23 wherein:
the core has an area weight in a range of 300-1,000 grams/square meter.

25. The formed article of claim 23 wherein:
the core layer is formed of at least one of polymer foam, honeycomb, cardboard, and metal mesh.

26. The formed article of claim 19 further comprising:
a decorative cover overlying the molded substrate.

27. The formed article of claim 26 wherein:
the decorative cover is formed from a sheet.
